(19) United States
(12) Patent Application Publication
(10) Pub. No.: US 2011/0065067 A1
(43) Pub. Date: Mar. 17, 2011

(54) STEERING FOR DRIVE SIMULATOR AND DRIVE SIMULATOR

(75) Inventors: Shigekazu Tanaka, Osaka (JP); Kaoru Hoshide, Tokyo (JP); Takashi Ogata, Tokyo (JP)

(73) Assignee: Shigekazu TANAKA, Kawachinagano-shi, Osaka (JP)

(21) Appl. No.: 12/667,150

(22) PCT Filed: Jun. 30, 2008
(86) PCT No.: PCT/JP2008/061866

§ 371 Date: Nov. 29, 2010

(30) Foreign Application Priority Data
Jun. 29, 2007 (JP) 2007-173084

(51) Int. Cl. G09B 9/02

(52) U.S. Cl. 434/29

(57) ABSTRACT

Provided is a drive simulator steering capable of offering a feeling of actually driving a car to a player. The steering for drive simulator of the present invention has a first screw shaft which is connectable to a steering wheel and rotatable around an axial line together with the steering wheel; a first nut which is fit on the first screw shaft and moves linearly in an axial direction of the first screw shaft with rotation of the first screw shaft; a second screw shaft which is connectable to a motor, in parallel with the first screw shaft and rotatable around the axial line; and a second nut which is fit on the second screw shaft, moves linearly in an axial direction of the second screw shaft with rotation of the second screw shaft 15 and is connected to the first nut.

### TECHNICAL FIRLED

The present invention relates to a drive simulator simulating a driving behavior of a vehicle, ship or the like and a steering therefor.

### BACKGROUND ART

There is known a drive simulator for a driver to operate a steering wheel, while watching an image displayed on a display unit. For example, a drive simulator for a game of displaying a view from a front window of a car on the display unit and a player watching the display unit while operating the steering wheel, gas pedal, a brake and a shift lever is offered commercially or installed on a game center as a game machine for business use.

FIG. 9 is a schematic view of a conventional steering for drive simulator. A steering wheel 1 is connected to a spur gear 2 of large diameter. The spur gear 2 of large diameter engages a spur gear 3 of small diameter. The spur gear 3 of small diameter is connected to a motor 4 which applies a load on the steering wheel 1. A rotational angle of the motor 4 is detected by an encoder 5.

When the spur gear 2 of large diameter engages the spur gear 3 of small diameter, the rotational speed of the motor 4 is reduced, which is transferred to the steering wheel 1. The motor 4 gives a torque of opposite direction to the steering wheel 1 when the player rotates the steering wheel 1, or gives rattling load to the steering wheel 1 when the car is moved onto a curbstone during the simulation. This is for giving the feeling of actually driving a car to the player

Here, though it is not the steering for drive simulator, the patent document 1 discloses use of a worm gear in the brake for drive simulator.

[Patent document 1] Japanese Patent Application Laid-open No. 2005-257029 (see claims)

### DISCLOSURE OF THE INVENTION

### Problems to be Solved by the Invention

However, in a conventional steering for drive simulator using gears in the deceleration mechanism, there is a problem that backlash occurs due to use of the gears. When the steering wheel is rotated, first there is a play corresponding to the backlash and then, the gears get abutting to each other. Each time the steering wheel is rotated, the play of backlash and rattling gear noise occur, which makes it difficult for the player to feel like driving a car actually. The play of backlash is different from a play of an actual car steering wheel and there is almost no play in the steering wheel of a racing car.

In addition, when there is a play of backlash, even if fine vibration is input from the motor, the vibration is absorbed into the play of backlash and is not transmitted to the steering wheel. Further, when the gears are used in the deceleration mechanism, the deceleration mechanism is arranged in the direction perpendicular to the center line of the steering wheel and therefore, the steering is shaped different from the steering of an actual car.

That is, in the steering for drive simulator using gears in the deceleration mechanism, there are problems that the player cannot feel like driving a car actually and is disappointed.

Then, the present invention has an object to provide a steering for drive simulator and a dive simulator capable of offering a player the feeling of driving an actual car.

### Means for Solving the Problems

The present invention will be described below, in which the reference numerals in the accompanying drawings are added within parentheses for easy understanding of the present invention, however, this is not intended for limiting the present invention to what is shown in the drawings.

In order to solve the above-mentioned problems, the invention of claim 1 is a steering for drive simulator comprising: a first screw shaft (12, 54) which is connectable to a steering wheel (61) and rotatable around an axial line together with the steering wheel (61); a first nut (13, 56) which is fit on the first screw shaft (12, 54) and moves linearly in an axial direction of the first screw shaft (12, 54) with rotation of the first screw shaft (12, 54); a second screw shaft (15, 55) which is connectable to a motor (68), in parallel with the first screw shaft (12, 54) and rotatable around the axial line; and a second nut (16, 57) which is fit on the second screw shaft (15, 55), moves linearly in an axial direction of the second screw shaft (15, 55) with rotation of the second screw shaft (15, 55) and is connected to the first nut (13, 56).

The invention of claim 2 is characterized in that in the steering for drive simulator of claim 1, a lead of the first screw shaft (12, 54) is greater than a lead of the second screw shaft (15, 55).

The invention of claim 3 is characterized in that in the steering for drive simulator of claim 1, a detector for detection a rotation angle of the first screw shaft (12, 54) is mountable on the first screw shaft (12, 54).

The invention of claim 4 is characterized in that in the steering for drive simulator of claim 1 or 2, the first nut (13, 56) is a first ball screw nut with a plurality of rolling elements (22) arranged rotatably between the first ball screw nut and the first screw shaft (12, 54), and the second nut (16, 57) is a second ball screw nut with a plurality of rolling elements arranged rotatably between the second ball screw nut and the second screw shaft (15, 55).

The invention of claim 5 is characterized by in the steering for drive simulator of anyone of claims 1 to 4, further comprising a stopper (50) made of viscoelasticity material for limiting moving amounts of the first nut (13, 56) and the second nut (16, 57) in the axial direction.

The invention of claim 6 is characterized by in the steering for drive simulator of anyone of claims 1 to 5, further comprising a linear motion guide (39) for guiding at least one of the first nut (13, 56) and the second nut (16, 57).

The invention of claim 7 is a drive simulator comprising: a steering for drive simulator having a steering wheel (61); an angle detector (67) for detecting a rotation angle of the steering wheel (61); a motor (68) for giving a load to the steering wheel (61); a display unit (66) for displaying an image; a simulation controller (70) for changing the image displayed on the display unit (66) based on a signal from an operation input part (73) including the steering wheel (61); a motor controller (69) for controlling the motor (68) based on the rotation angle detected by the angle detector (67); and the steering for drive simulator having a first screw shaft (12, 54) which is connectable to the steering wheel (61) and rotatable around an axial line together with the steering wheel (61); a first nut (13, 56) which is fit on the first screw shaft (12, 54) and moves linearly in an axial direction of the first screw shaft (12, 54) with rotation of the first screw shaft (12, 54); a second screw shaft (15, 55) which is connectable to the motor (68), in parallel with the first screw shaft (12, 54) and rotatable around the axial line; and a second nut (16, 57) which is fit on the second screw shaft (15, 55), moves linearly in an axial direction of the second screw shaft (15, 55) with rotation of the second screw shaft (15, 55) and is connected to the first nut (13, 56).

### EFFECTS OF THE INVENTION

According to the invention of claim 1, as the two-stage screw mechanisms are combined into the deceleration mechanism of the steering for drive simulator, the play of the deceleration mechanism can be reduced. In addition, as the shape is such as extending straightly from the steering wheel, it is close to the steering of an actual car.

According to the invention of claim 2, as rotation of the motor is decelerated to be transferred to the steering wheel, conversely, it becomes possible to accelerate the rotation of the steering wheel and transfer it to the motor.

According to the invention of claim 3, it is possible to detect the rotational angle of the steering wheel directly. On the other hand, when the rotational angle of the second screw shaft is detected, it needs to be converted into the rotational angle of the first screw shaft.

According to the invention of claim 4, as the first and second nuts are ball screw nuts, it is possible to reduce the backlash to zero.

According to the invention of claim 5, when the first nut and the second nut abut to the stopper of viscoelasticity material to limit the rotation of the steering wheel, it is possible to give the player a feeling close to the feeling of driving a car actually.

According to the invention of claim 6, if moment is applied to the first nut and the second nut, they can be moved in the axial direction.

According to the invention of claim 7, as the two-stage screw mechanisms are combined into the deceleration mechanism of the steering for drive simulator, the play of the deceleration mechanism can be reduced. In addition, as the shape is such as extending straightly from the steering wheel, it is close to the steering of an actual car.

### BRIEF DESCRIPTION OF THE DRAWINGS

FIG. 1 is a perspective view of a steering according to one embodiment of the present invention.

FIG. 2 is a plan view of the steering.

FIG. 3 is a side view of the steering.

FIG. 4 is a perspective view of a first ball screw mechanism.

FIG. 5 is a perspective view illustrating an actuator having integrally formed linear motion guide and second ball screw mechanism.

FIG. 6 is a cross sectional view of another example of the steering.

FIG. 7 is an outline view of a drive simulator.

FIG. 8 is an overall structural view of the drive simulator.

FIG. 9 is a schematic view of a conventional steering.

### REFERENCE NUMERALS

12, 54 . . . first screw shaft
13, 56 . . . first ball screw nut (first nut)
15, 55 . . . second screw shaft
16, 57 . . . second ball screw nut (second nut)
22 . . . ball (rolling element)
34 . . . rail
37 . . . ball train
39 . . . liner motion guide
50 . . . stopper
51 . . . rail
53 . . . rolling element
61 . . . steering wheel (operation input section)
62 . . . gas pedal (operation input section)
63 . . . brake (operation input section)
64 . . . shift lever (operation input section)
66 . . . display unit
67 . . . angle detector
68 . . . motor
69 . . . motor driver (motor controller)
70 . . . simulation controller
72 . . . display unit
73 . . . operation input section

### BEST MODE FOR CARRYING OUT THE INVENTION

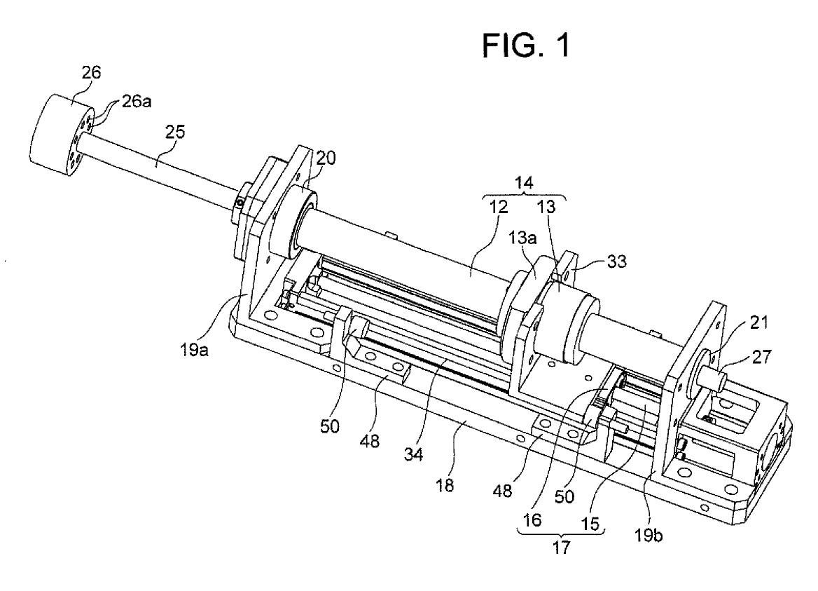

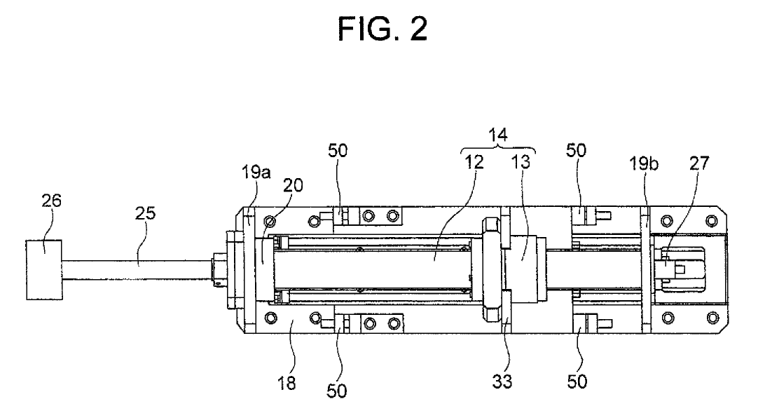

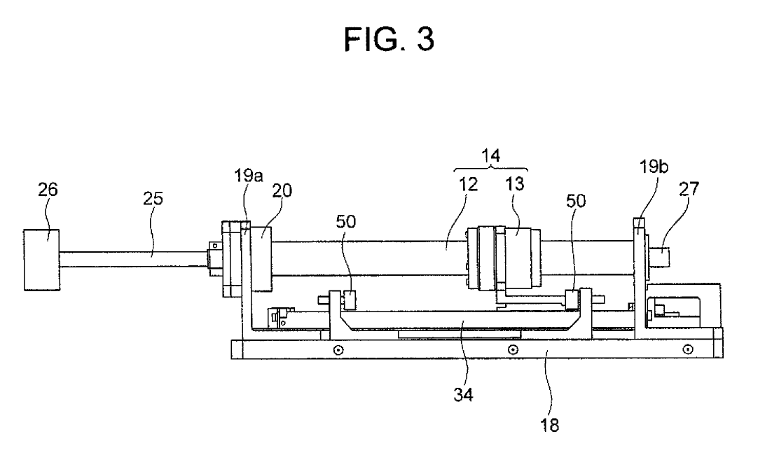

With reference to the attached drawings, a steering for drive simulator (hereinafter also referred simply to “steering”) according to an embodiment of the present invention will be described below. FIGS. 1 to 3 are overall views of the steering. FIG. 1 is a perspective view, FIG. 2 is a plan view and FIG. 3 is a side view of the steering. The steering has combination of a first ball screw mechanism 14 and a second ball screw mechanism 17 vertically aligned at two stages. A screw shaft 12 of the upper-stage first ball screw mechanism and a screw shaft 15 of the lower-state ball screw mechanism 17 are in parallel with each other.

The lead of the first screw shaft 12 is greater than that of the second screw shaft 15. For example, a ratio of the lead of the first screw shaft 15 to the lead of the second screw shaft 15 is set to be 30 to 50:1. Rotation of the second screw shaft 15 is decelerated to, for example, 1/(30 to 50) and transmitted to the first screw shaft 12. On the other hand, rotation of the first screw shaft 12 is accelerated by 30 to 50 times to be transmitted to the second screw shaft 15.

The steering has an elongating and rectangular base plate 18. At both ends of the base plate 18 in the longitudinal direction, a pair of brackets 19a, 19b is attached to support the first screw shaft 12 rotatable. The first screw shaft 12 is supported by the brackets 19a, 19b via bearings 20 and 21 so as to rotate around the axial line.

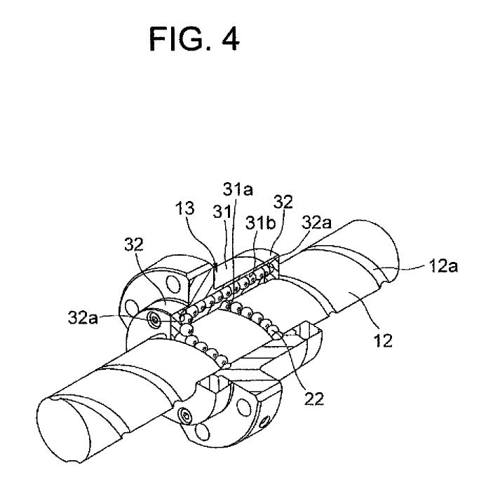

In an outer circumferential surface of the first screw shaft, a spiral ball rolling groove 12a is worked with a predetermined lead (see FIG. 4). As balls 22 roll thereon as rolling elements, the surface of the ball rolling groove 12a is finished to be smooth and have high strength (rigidity).

As illustrated in FIG. 1, the first screw shaft 12 is connected at an end thereof to a wheel connection shaft 25. The center line of the first screw shaft 12 and the center line of the wheel connection shaft 25 are in agreement with each other. At the tip end of the wheel connection shaft 25, a wheel holding section 26 is provided in shape of circular cylinder. The wheel holding section has a plurality of mounting holes 26a in the circumferential direction. When mounting screws are made to pass through the mounting holes 26a to fit in the steering wheel attached to the wheel holding section 26, the steering wheel is fixed to the wheel holding section 26.

At the other end of the first screw shaft 12, a detection shaft 27 jutting from the bracket 19b is connected thereto. An angle detector (not shown) such as an encoder is attached to the detection shaft 27. As the detection shaft 27 is connected to the first screw shaft 12, the angle detector is able to detect a rotation angle f the steering wheel directly.

FIG. 4 is a detailed view of a firs nut (first ball screw nut) fit in the first screw shaft 12. The first ball screw nut 13 has a nut main body 31 having a loaded ball rolling groove 31a formed in the inner surface thereof and a pair of endcaps provided at respective ends of the nut main body 31. As the balls 22 roll thereon, the surface of the loaded ball rolling groove 31a is finished to be smooth and have high strength. The nut main body 31 has a ball return passage 31b passing through the nut main body in the axial direction for circulation of the balls 22. In each of the endcaps 32, a direction change passage 32a is formed scooping each ball 22 rolling in the ball rolling groove 12a of the first screw shaft 12 to lead the ball to the ball return passage 31b.

A loaded ball rolling passage between the ball rolling groove 12a of the first screw shaft 12 and the loaded ball rolling groove 31a of the nut main body 31, the direction change passages 32a and ball return passage 31a consist in a ball circulation passage in which the plural balls 22 are arranged.

When the first screw shaft 12 is rotated, the first ball screw nut 13 fit on the first screw shaft 12 via the balls 22 moves in the axial direction. At the same time, the balls 22 circulate in the ball circulation passage. Once each of the balls 22 roll up to an end of the loaded ball rolling passage, it is scooped up into the direction change passage 32a of the endcap 32, moves in the ball return passage 31b and then is returned from the opposite-side endcap 32 back into the other end of the loaded ball rolling passage.

Here, the ball circulation passage may be, instead of the above-described endcap type ball circulation passage, a return pipe type circulation passage or a deflector type circulation passage.

As illustrated in FIG. 1, the flange 13a of the first ball screw nut 13 is connected to an L-shaped bracket 33. To the bottom surface of the L-shaped bracket 33, the second ball screw nut 16 as a second nut is connected.

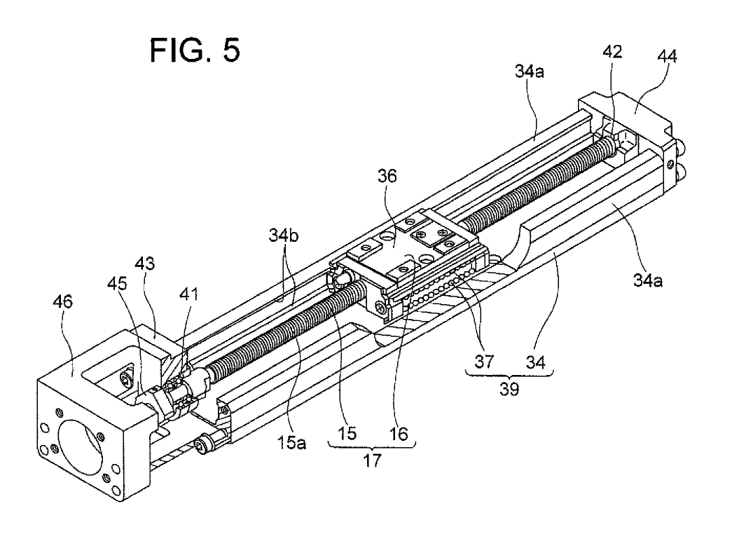

FIG. 5 illustrates an actuator having the second ball screw device 17, a linear motion guide 39 integrally provided therein. A block 36 is arranged inside of side walls 34a of a rail 34 of U-shaped cross section. The block 36 sandwiched between the side walls 34a in pair of the rail 34 moves linearly in the longitudinal direction of the rail 34 along the rail 34. In both side surfaces of the block 36, a plurality of ball trains 37 is arranged. At the inside of the side wall 34a of the rail 34, ball rolling grooves 34b are formed extending in the longitudinal direction of the rail 34. The ball rolling grooves 34b guide rolling of ball trains 37 in both side surfaces. The rail 34 and the ball trains 37 in both side surfaces of the block 36 consist in the linear motion guide 39 for guiding linear motion of the block 36.

Here, the linear guide part 39 may be a linear guide having a raceway rail and a saddle-shaped moving block arranged thereon or a ball spline having a spline shaft and an outer cover moving along the spline shaft as far as it can guide linear movement of the second ball screw nut 16.

The second screw shaft 15 of the second ball screw mechanism 17 passes through the block 36. In the outer surface of the second screw shaft 15, ball rolling grooves 15a are formed with a predetermined lead. The lead of the second screw shaft 15 is smaller than that of the fist screw shaft 12. As the balsas rolling elements roll thereon, the surfaces of the ball rolling grooves 15a are finished to be smooth and have high strength (rigidity).

Both ends of the second screw shaft 15 are supported by end housings 43 and 44 provided at both ends of the rail 34 in the longitudinal direction via the bearings 41 and 42. The second screw shaft 15 is able to rotate round the axial line. At an end of the second screw shaft 15, a joint 45 is attached thereto. At an end of the rail 34 in the longitudinal direction, a motor support housing 46 is provided on which a motor is mounted. The motor is connected to the second screw shaft 15 by mounting the motor on the motor support housing 46 and connecting an output shaft of the motor to the joint 45.

In the block 36, the second ball screw nut 16 is embedded. The ball screw nut 16 is fit on the second screw shaft 15 passing in the block 36. In the inner surface of the second ball screw nut 16, like the first ball screw nut 13, a spiral loaded ball rolling groove is formed facing the ball rolling groove 15a of the second screw shaft 15. Besides, the second ball screw nut 16 has a ball circulation passage including the loaded ball rolling groove. The type of the ball circulation passage may be, like the first ball screw nut 13, the return pipe type, the endcap type, the deflector type or any other type. In the ball circulation passage, a plurality of balls is arranged. When the second screw shaft 15 is rotated, the second ball screw nut 16 moves in the axial direction and the plural ball circulates in the ball circulation passage.

The next description is made about the operation of a deceleration mechanism when the lead of the first ball screw mechanism 14 is, for example, 30 to 50 mm and the lead of the second ball screw mechanism 17 is, for example 1 mm (see FIG. 1). In this case, when the steering wheel is rotated one turn, the first ball screw nut 13 moves 30 to 50 mm linearly. As the first ball screw nut 13 and the second ball screw nut 16 are connected to each other, the second ball screw nut 16 also moves 30 to 50 mm linearly together with the first ball screw nut 13. When the second ball screw nut 16 moves linearly, the linear motion of the second ball screw nut 16 is converted into rotation and the second screw shaft 15 rotates. As the lead of the second ball screw mechanism 17 is 1 mm, when the second ball screw nut 16 moves 30 to 50 mm linearly, the second screw shaft 15 rotates 30 to 50 turns. On the other hand, when the motor is used to rotate the second screw shaft 15, when the second screw shaft 15 rotates 30 to 50 turns, the first screw shaft 12 rotates one turn.

The motor is provided to give the steering wheel a load. For example, when the player rotates the steering wheel, the motor gives a torque in the opposite direction to the direction where the player rotates the wheel. This is for giving the player an operation feeling line operating an actual car. The torque with which the player rotates the steering wheel is significantly large. If the motor is connected to the first screw shaft, a huge motor would be required to create a torque corresponding to the torque of the player. As the output shaft of the motor is decelerated to be transmitted to the first screw shaft 12, the motor can be downsized (the motor torque can be reduced to 1/30 to 50 in the present embodiment), and a motor of appropriate size can be selected to be embedded in the steering.

In addition, as the balls 22 are interposed between the first ball screw nut 13 and the first screw shaft 12 and preloaded, the space in the first ball screw mechanism 14 can be reduced to zero. Likewise, as the balls are interposed between the second ball screw nut 16 and the second screw shaft 15 and preloaded, the space in the second ball screw mechanism 17 can be reduced to zero. As these first ball screw mechanism 14 and second ball screw mechanism 17 are combined into the deceleration mechanism and the space in this deceleration mechanism can be reduced to zero, the deceleration mechanism can be provided with no play.

As illustrated in FIG. 1, on the base plate 18, stoppers 50 are provided via respective stopper support plates 48. The stoppers 50 are made of viscoelasticity material such as urethan or rubber. The plural stoppers 50 are provided facing each other with a predetermined space given in the longitudinal direction of the base plate 18. When the lower part of the L-shaped bracket 33 fixed to the first ball screw nut 13 abuts to the stopper 50, movement in the axial direction of the first ball screw nut 13 and the second ball screw nut 16 is restricted. The stoppers 50 also limit the rotation angle in the clockwise and counterclockwise directions of the steering wheel.

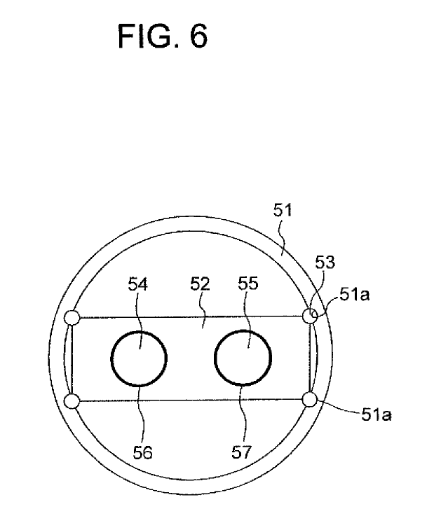

FIG. 6 is a cross sectional view illustrating another example of the steering. In a tube-shaped rail 51, a block 52 is held movable in the axial direction. Movement of the block 52 is guided by a linear motion guide, that is, rolling elements 53 and ball rolling grooves 51a in the inner circumferential surface of the rail 51. In the block 52, a first screw shaft 54 and the second screw shaft 55 pass therethrough. A first ball screw nut 56 is fit on the first screw shaft 54 and a second ball screw nut 57 is fit on the second screw shaft 55. As the first screw shaft 54 and the second screw shaft 55 are held in tube-shaped rail 51, the steering can be of compact size.

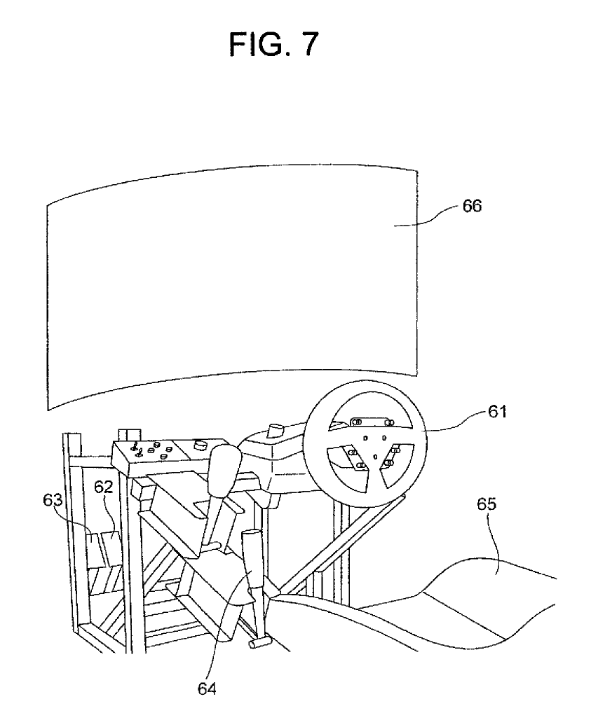

FIG. 7 is an outline view of a drive simulator having the steering of the present invention embedded therein. In the drive simulator, a steering wheel 61, a gas pedal 62, a brake 63, a shift lever 64 and the like are arranged as operation input part operable by a player. The player sits on a seat 65 and operates the operation input part such as the steering wheel 61 while watching a display unit 66 arranged in front thereof. On the display device 66, for example, a racing car driving in a town course or a circuit course is displayed. Then, the player drives the racing car and competes against computer cars driven by a simulator controller as to ranking or driving time.

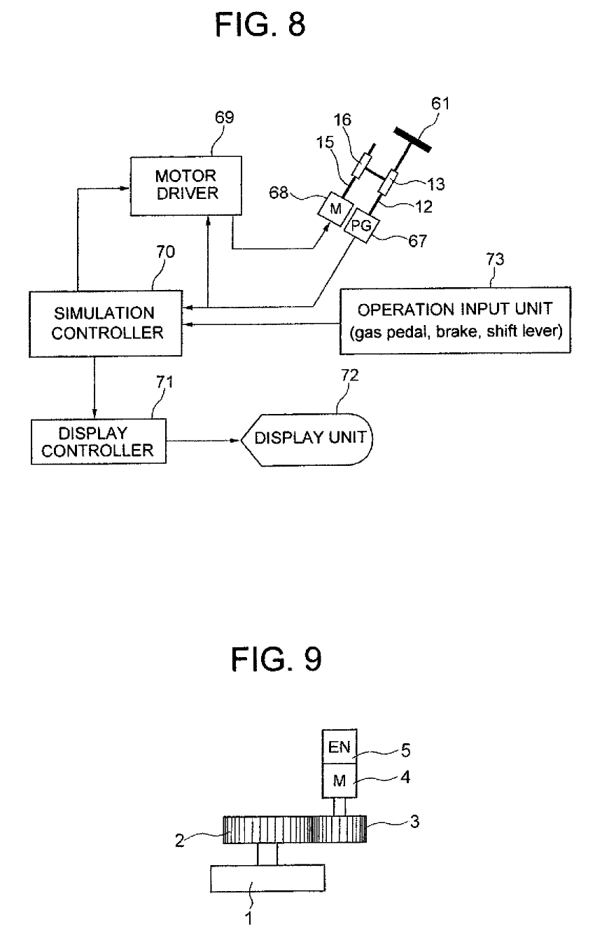

FIG. 8 is an overall structural view of the drive simulator. The drive simulator has the steering wheel 61, an angle detector 67 such as an encoder connected to the first screw shaft 12 of the steering, a motor 68 which is connected to the second screw shaft 15 of the steering and gives a load to the steering wheel 61, a motor driver 69 as motor controller for controlling the motor 68, a simulation controller 70 for executing drive simulation, a display controller 71 for creating various image data and a display unit 72 for displaying the image data.

The motor driver 69 controls the motor 68 for giving a load to the steering wheel 61. The motor driver 69 receives a rotation angle signal of the steering wheel 61 detected by the angle detector 67. The motor driver 69 calculates a rotation angle and a rotation speed of the steering wheel 61.

The simulation controller 70 calculates a parameter in accordance with progress of a game or speed of the racing car driven by the player and outputs it to the motor driver 69. The motor driver 69 uses the parameter output from the simulation controller 70 and the rotation angle and rotation speed of the steering wheel 61 as a basis to control a current (torque) passing through the motor 68. With this structure, the steering wheel 61 can be given a reaction force close to that of an actual racing car. For example, when the rotation angle of the steering wheel 61 is larger and the car speed is higher, the motor driver 69 controls to increase the torque of the motor 68. On the other hand, when the racing car runs over the curbstone, for example, the motor driver 69 increases and reduces the torque to the motor 68 so that a rattling load to the steering wheel 61.

The simulation controller 70 performs various calculations relating to drive games in accordance with operations of the operation input part 73 including the steering wheel, a gas pedal, a brake, a shift lever and the like. The calculation results are sent to the display controller 71. The display controller 71 creates various image data and displays it on a display unit 72. For example, the display unit 72 displays a front scenery that can be viewed by a player via a front window of a racing car.

Here, the simulation controller may make such a control that the seat 65 is inclined so as to give a player a sense of acceleration while the game is in process and the seat 65 is swayed for example when the racing car runs on a curbstone.

The present invention is not limited to the above-described embodiments but may be embodied in various forms without departing from the scope of the present invention. For example, the first ball screw mechanism and the second screw mechanism may be sliding type screw mechanisms with no rolling element arranged therein.

Further, the steering for drive simulator of the present invention is applicable not only to game machines but also drive simulators in driving schools and the like. Also, it is applicable not only to cars but also other vehicles such as ships.

1. A steering for drive simulator comprising:
a first screw shaft which is connectable to a steering wheel and rotatable around an axial line together with the steering wheel;
a first nut which is fit on the first screw shaft and moves linearly in an axial direction of the first screw shaft with rotation of the first screw shaft;
a second screw shaft which is connectable to a motor, in parallel with the first screw shaft and rotatable around the axial line; and
a second nut which is fit on the second screw shaft, moves linearly in an axial direction of the second screw shaft with rotation of the second screw shaft and is connected to the first nut.

2. The steering for drive simulator of claim 1, wherein a lead of the first screw shaft is greater than a lead of the second screw shaft.

3. The steering for drive simulator of claim 1, wherein a detector for detection a rotation angle of the first screw shaft is mountable on the first screw shaft.

4. The steering for drive simulator of claim 1, wherein the first nut is a first ball screw nut with a plurality of rolling elements arranged rotatably between the first ball screw nut and the first screw shaft, and the second nut is a second ball screw nut with a plurality of rolling elements arranged rotatably between the second ball screw nut and the second screw shaft.

5. The steering for drive simulator of claim 1, further comprising a stopper made of viscoelasticity material for limiting moving amounts of the first nut and the second nut in the axial direction.

6. The steering for drive simulator of claim 1, further comprising a linear motion guide for guiding at least one of the first nut and the second nut.

7. A drive simulator comprising:
a steering for drive simulator having a steering wheel;
an angle detector for detecting a rotation angle of the steering wheel;
a motor for giving a load to the steering wheel;
a display unit for displaying an image;
a simulation controller for changing the image displayed on the display unit based on a signal from an operation input part including the steering wheel;
a motor controller for controlling the motor based on the rotation angle detected by the angle detector; and
the steering for drive simulator having
a first screw shaft which is connectable to the steering wheel and rotatable around an axial line together with the steering wheel;
a first nut which is fit on the first screw shaft and moves linearly in an axial direction of the first screw shaft with rotation of the first screw shaft;
a second screw shaft which is connectable to the motor, in parallel with the first screw shaft and rotatable around the axial line; and
a second nut which is fit on the second screw shaft, moves linearly in an axial direction of the second screw shaft with rotation of the second screw shaft and is connected to the first nut.

8. The steering for drive simulator of claim 2, wherein the first nut is a first ball screw nut with a plurality of rolling elements arranged rotatably between the first ball screw nut and the first screw shaft, and the second nut is a second ball screw nut with a plurality of rolling elements arranged rotatably between the second ball screw nut and the second screw shaft.

9. The steering for drive simulator of claim 2, further comprising a stopper made of viscoelasticity material for limiting moving amounts of the first nut and the second nut in the axial direction.

10. The steering for drive simulator of claim 3, further comprising a stopper made of viscoelasticity material for limiting moving amounts of the first nut and the second nut in the axial direction.

11. The steering for drive simulator of claim 4, further comprising a stopper made of viscoelasticity material for limiting moving amounts of the first nut and the second nut in the axial direction.

12. The steering for drive simulator of claim 2, further comprising a linear motion guide for guiding at least one of the first nut and the second nut.

13. The steering for drive simulator of claim 3, further comprising a linear motion guide for guiding at least one of the first nut and the second nut.

14. The steering for drive simulator of claim 4, further comprising a linear motion guide for guiding at least one of the first nut and the second nut.

15. The steering for drive simulator of claim 5, further comprising a linear motion guide for guiding at least one of the first nut and the second nut.
